(19) United States
(12) Patent Application Publication
(10) Pub. No.: US 2020/0380469 A1
(43) Pub. Date: Dec. 3, 2020

(54) Open Source Movie Stories

(71) Applicant: Wei Liu, Memphis, TN (US)

(72) Inventor: Wei Liu, Memphis, TN (US)

(21) Appl. No.: 16/425,617

(22) Filed: May 29, 2019

(51) Int. Cl. G06Q 10/10

(52) U.S. Cl. CPC G06Q 10/101

(57) ABSTRACT

Open-source stories, scripts, lines of movies, TV programs, or books to allow anyone willing to contribute to create a coherent product.

### CROSS-REFERENCE TO RELATED APPLICATIONS

None

### STATEMENT REGARDING FEDERALLY SPONSORED RESEARCH OR DEVELOPMENT

This is solely my personal invention and is NOT made with or related to federal funding.

### REFERENCE TO A “SEQUENCE LISTING”

None

### BACKGROUND OF THE INVENTION

I came upon this idea of open-sourcing stories, scripts, and lines when I thought about writing a movie story.

### BRIEF SUMMARY OF THE INVENTION

This invention is to create an approach of open-sourcing stories, scripts, and lines of movies, TV program, or books from anyone who is willing to contribute.

### BRIEF DESCRIPTION OF DRAWINGS

No drawing is necessary and thus not provided herein.

### DETAILED DESCRIPTION OF THE INVENTION

This invention is to create an approach of open-sourcing stories, scripts, and lines of movie, TV programs, or books from anyone who is willing to contribute and to combine all the relevant contributions into a coherent product.

1. This is to claim the invention of open-sourcing stories, scripts, and lines of movie, TV program, or books and combine all the relevant contributions in a coherent product.
